(19) United States
(12) Patent Application Publication
(10) Pub. No.: US 2006/0195662 A1
(43) Pub. Date: Aug. 31, 2006

(54) Method for deterministic cache partitioning

(75) Inventor: Frank M. Folio, Scottsdale, AZ (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International, Inc.

(21) Appl. No.: 11/068,194

(22) Filed: Feb. 28, 2005

(51) Int. Cl. G06F 12/00

(52) U.S. Cl. 711/129

(57) ABSTRACT

A method is provided for partitioning a data cache for a plurality of applications. The method includes loading the data cache with a first data in a first frame, and loading the data cache with a second data within the first frame after loading the data cache with the first data. The first data is uncommon to the plurality of applications, and the first frame indicates a first sequence of the plurality of applications. The second data corresponds to a first application in the first sequence of the plurality of applications.

### FIELD OF THE INVENTION

The present invention generally relates to data storage in computer systems, and more particularly relates to computer systems in which data is temporarily stored into a cache from a memory.

### BACKGROUND OF THE INVENTION

The basic components of almost all conventional computer systems include a processor and a main memory. The processor typically retrieves data and/or instructions from the main memory for processing by the processor, and the processor then stores the results of the processing back into the main memory. At times, memory access by the processor may be slow. Generally, each kind of memory has a latency, which refers to the length of time from when a processor first requests either data or an instruction stored in the memory, to when the processor receives the data or the instruction from the memory. Different memory locations within a computer system may have different latencies. The latency generally limits the performance of the processor because the processor typically processes instructions and performs computations faster than the memory provides the data and instructions to the processor.

To alleviate such latency limitations, many computer systems utilize one or more memory caches. A memory cache or processor cache refers to a memory bank that bridges the main memory and the processor, such as a central processing unit (CPU). The CPU generally retrieves data and instructions from the memory cache faster than the CPU retrieves data and instructions from the main memory. By retrieving data and instructions from the memory cache, the CPU executes instructions and reads data at higher speeds. Thus, caches on modern processors typically provide a substantial performance improvement over external memory.

Two common types of caches include a Level 1 (L1) cache and a Level 2 (L2) cache. The L1 cache refers to a memory bank incorporated into the processor, and the L2 cache refers to a secondary staging area, separate from the processor, that feeds the L1 cache. An L2 cache may reside on the same microchip as the processor, reside on a separate microchip in a multi-chip package module, or be configured as a separate bank of chips.

For effective real time operation, the computer system generally operates with a reasonable degree of certainty that the cache contains particular data items or instructions at a given time. Most existing refill mechanisms attempt to place a requested data item or instruction in the cache during execution of a particular application and remove or flush other data items or instructions in the cache to make room for the requested data item or instruction. Furthermore, a computer system typically operates multiple applications at one time. To provide the reasonable degree of certainty, the computer system treats the caches as shared resources among the multiple applications in a deterministic manner and has a cache allocation policy that addresses the availability of the caches for one or more applications.

Some computer systems operate with time partitioning such that an application has access to the cache within a predetermined time period and without concern that other applications may access the cache within such predetermined time period. Partitioned cache based computer systems flush the L1 cache for each partition to remove the contents of the L1 cache between each running application. During execution of an application, the application has a deterministic cache state indicating an empty L1 cache, and the application may then fill the L1 cache with data relevant to the application thereby providing a deterministic throughput. However, flushing the L1 cache can consume a significant amount of time when compared with the internal throughput of the processor. For example, flushing the cache for each application may occupy more than twenty percent (20%) of the available throughput of the processor.

Accordingly, it is desirable to provide a method for cache partitioning that reduces processor cache overhead and increases available throughput of the processor. In addition, it is desirable to provide a method for cache partitioning having deterministic application throughput for each executed application while reducing processor cache overhead. Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

A method is provided for partitioning a data cache for a plurality of applications. The method comprises loading the data cache with a first data in a first frame, and loading the data cache with a second data within the first frame after loading the data cache with the first data. The first data is uncommon to the plurality of applications, and the first frame indicates a first sequence of the plurality of applications. The second data corresponds to a first application in the first sequence of the plurality of applications.

In a computer system having a data cache, an instruction cache, and a memory, the computer system operating a plurality of applications, a method is provided for partitioning the data cache. The method comprises loading the data cache with a first data in a first frame, and loading the data cache with a second data after loading the data cache with the first data. The first data is unrelated to the plurality of applications, and the first frame indicates a first scheduling sequence of the plurality of applications. The second data corresponds to a first application in the first scheduling sequence of the plurality of applications.

A computer program product is provided for causing an operating system to manage a data cache during operation of a plurality of processes. The program product comprises a computer usable medium having a computer readable program code embodied in the medium that when executed by a processor causes the operating system to load the data cache with a first data in a first frame, and load the data cache with a second data within the first frame and after loading the data cache with the first data. The first data is uncommon to the plurality of processes, and the first frame indicates a first sequence of the plurality of processes. The second data corresponds to a first application in the first sequence of the plurality of processes.

### BRIEF DESCRIPTION OF THE DRAWINGS

The present invention will hereinafter be described in conjunction with the following drawing figures, wherein like numerals denote like elements, and

FIG. 1 is a block diagram of a computer system having a data cache in accordance with an exemplary embodiment;

FIG. 2 is a graph illustrating cache frame based partitioning in accordance with an exemplary embodiment;

FIG. 3 is a graph illustrating the data flush to the main memory from the data cache frame based partitioning shown in FIG. 2; and

FIG. 4 is a flowchart of a method for partitioning a data cache in accordance with an exemplary embodiment.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

Generally, a method is provided for partitioning a data cache for a plurality of applications. The method comprises loading the data cache with a first data in a first frame, and loading the data cache with a second data within the first frame after loading the data cache with the first data. The first data is uncommon to the plurality of applications, and the first frame indicates a first sequence of the plurality of applications. The second data corresponds to a first application in the first sequence of the plurality of applications. The method can be implemented as a computer readable program code embodied in a computer-readable medium stored on an article of manufacture, and the medium may be a recordable data storage medium or another type of medium.

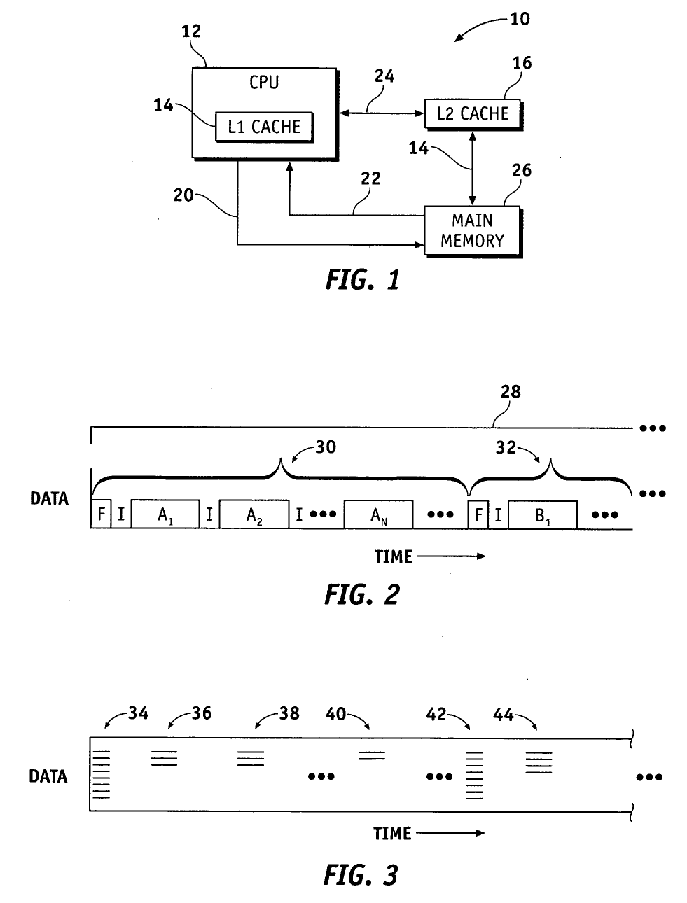

Referring to FIG. 1, a computer system 10 having a data cache is illustrated in accordance with an exemplary embodiment. The computer system includes, but is not necessarily limited to, a Central Processing Unit (CPU) 12, a data cache 14, 16 coupled to the CPU 12, and a main memory 18 coupled to the CPU 12 via an address bus 20 and a data bus 22. The CPU 12 executes any number of applications or processes, such as in accordance with an operating system, and accesses information (e.g., data, instructions, and the like) in the main memory 18 using the address bus 16 and returns information to the CPU 12 from the main memory 18 using the data bus 20.

The data cache 14, 16 includes, but is not necessarily limited to, a Level 1 (L1) cache 14 and a Level 2 (L2) cache 16. The L1 cache 14 is a memory bank(s) in the CPU 12. Although the L1 cache 14 and L2 cache 16 are shown and described as separated from the CPU 12, each of the L1 cache and L2 cache 16 may reside on the same microchip as the CPU 12, reside on a separate microchip in a multi-chip package module, or be configured as a separate bank of microchips. The CPU 12 may fill the L2 cache 16 with information from the CPU 12 using an address/data bus 24, and the L2 cache 16 is coupled to the main memory 18 via a bus 26 for transferring replacement information, data items or instructions, and addresses between the L2 cache 16 and the main memory 18. During the course of executing various applications or processes, the CPU 12 may fill either the L1 cache 14 or the L2 cache 16, or both, with data or instructions that are relevant to the particular executed application or processes. The components of the computer system 10 relevant to the exemplary embodiments are illustrated, and other components may be included in the computer system 10 that are not illustrated or described herein as appreciated by those of skill in the art.

Although the computer system 10 is described with regard to the CPU 12, the computer system 10 may include other types of processors as well, such as co-processors, mathematical processors, service processors, input-output (I/O) processors, and the like. For convenience of explanation, the term data cache is used herein to refer to the L1 cache 14, the L2 cache 16, or a combination of both the L1 cache 14 and L2 cache 16. The main memory 16 is the primary memory in which data and computer instructions are stored for access by the CPU 12. The main memory 16 preferably has a memory size significantly larger than the size of either the L1 cache 14 or the L2 cache 16. The term memory is used generally herein and encompasses any type of storage, such as hard disk drives and the like.

FIG. 2 is a graph illustrating cache frame based partitioning in accordance with an exemplary embodiment. The data and/or instructions received by the data cache are time partitioned and preferably time partitioned into multiple major frames 28 comprising multiple minor frames 30, 32. Each major frame 28 is preferably partitioned based on a time period sufficient to schedule slower rate applications or processes performed by the CPU 12 shown in FIG. 1. Each minor frame 30, 32 is time partitioned and preferably partitioned based on a time period sufficient to schedule faster rate applications or processes performed by the CPU 12 shown in FIG. 1. Each minor frame 30, 32 has a scheduled sequence of applications or processes, and each application or process may use different amounts of the data cache for different amounts of time. For example, a first minor frame 30 has a scheduled sequence of applications A₁, A₂, . . . , A_{N}, and a second minor frame 32 has a scheduled sequence of applications B₁, etc.

At the start of each minor frame 30, 32, the CPU 12 shown in FIG. 1 fills the data cache with data (F) uncommon to the scheduled applications and subsequently fills the data cache with data pertaining to a particular scheduled application. For example, at the start of the minor frame 30, the CPU 12 shown in FIG. 1 fills the data cache with data (F) uncommon to the scheduled applications A₁, A₂, . . . , A_{N}. The CPU 12 shown in FIG. 1 subsequently loads data relevant to a first scheduled application Al into the data cache and flushes the data in the data cache (i.e., data uncommon to the scheduled applications A₁, A₂, A_{N}) to be occupied by the data relevant to the first scheduled application A₁. Data flushed from the data cache by the CPU 12 shown in FIG. 1 is sent to the main memory 18, as described in greater detail hereinafter.

Following the first scheduled application A₁, the CPU 12 shown in FIG. 1 loads data relevant to a second scheduled application A₂ into the data cache and flushes the data in the data cache (i.e., data uncommon to the second scheduled application A₂) to be occupied by the data relevant to the second scheduled application A₂. The data relevant to each scheduled-application in a particular minor frame is preferably uncommon to subsequently scheduled applications of the particular minor frame, and thus each scheduled application in the particular minor frame sees a deterministic cache. For example, the data relevant to the second scheduled application A₂ is not common to the other scheduled applications within the minor frame.

Following the second scheduled application A₂, the CPU 12 shown in FIG. 1 sequentially fills the data cache and flushes data from the data cache for the remaining scheduled applications in the minor frame 30, 32 in a similar manner as the second scheduled application A₂. At the start of a scheduled application in the minor frame 30, the data cache contains data that is common to such scheduled application, and thus, the computer system 10 shown in FIG. 1 provides a deterministic application throughput. The computer system 10 may be configured with an instruction cache such as by designating a portion of either the L1 cache 14 or the L2 cache 16 as the instruction cache. In the event that the computer system 10 is configured with the instruction cache, the CPU 12 shown in FIG. 1 additionally invalidates (I) the instruction cache between each scheduled application and after filling the data cache with the data uncommon to the scheduled applications for each particular minor frame.

At the start of the second minor frame 32, the CPU 12 shown in FIG. 1 fills the data cache with data (F) uncommon to the scheduled applications (e.g., B₁, . . . ) for the second minor frame 32. The CPU 12 shown in FIG. 1 subsequently loads data relevant to a first scheduled application B₁ for the second minor frame 32 into the data cache and flushes the data in the data cache (i.e., data uncommon to the scheduled applications B₁, etc.) to be occupied by the data relevant to the first scheduled application B₁ in the second minor frame 32. Following the first scheduled application B₁, the CPU 12 shown in FIG. 1 loads data relevant to the remaining scheduled applications for the second minor frame 32 into the data cache and flushes the data in the data cache in a similar manner as performed for the other scheduled applications A₂, . . . , A_{N} of the first minor frame 30.

FIG. 3 is a graph illustrating the data flush to the main memory 18 from the cache frame based partitioning shown in FIG. 2. For each loading of data into the data cache, the CPU 12 flushes or transfers data in the data cache to the main memory 18 shown in FIG. 1, and the amount of data flushed from the data cache depends on the amount of data relevant to a currently executed application or process. At the start of each minor frame 30, 32 shown in FIG. 2, the CPU 12 shown in FIG. 1 flushes all of the data 34, 42 in the data cache to the main memory 18 shown in FIG. 1 when loading the data (F) uncommon to the scheduled applications of a particular minor frame 30, 32 shown in FIG. 2. For example, at the start of the first minor frame 30 shown in FIG. 2, the CPU 12 shown in FIG. 1 flushes all of the data 34 contained in the data cache to the main memory 18 shown in FIG. 1 when loading the data cache with the data uncommon to the scheduled applications for the first minor frame.

Each scheduled application (e.g., A₁, A₂, . . . , and A_{N}) may process more or less data and thus occupy more or less cache lines in the data cache, and the CPU 12 shown in FIG. 1 flushes, a corresponding number of cache lines in the data cache sufficient for occupation by the data relevant to a currently executed scheduled application. For example, the CPU 12 shown in FIG. 1 flushes cache lines 36 for the first scheduled application A₁ to the main memory 18 shown in FIG. 1, flushes cache lines 38 for the second schedule application A₂ to the main memory 18 shown in FIG. 1, and so on until the CPU 12 shown in FIG. 1 flushes cache lines 40 for the Nth scheduled application A_{N} to the main memory 18 shown in FIG. 1. Similarly for other minor frames (e.g., the second minor frame 32), the CPU 12 shown in FIG. 1 flushes cache lines, such as cache lines 44 for the first scheduled application B, of the second minor frame 32, to the main memory 18 shown in FIG. 1 for each scheduled application within a particular minor frame. Thus, by pre-filling the data cache with data uncommon to any of the application within a particular minor frame, the CPU 12 shown in FIG. 1 has a performance generally limited to flushing the cache line(s) of the data cache to be occupied by the data relevant to a currently executed application.

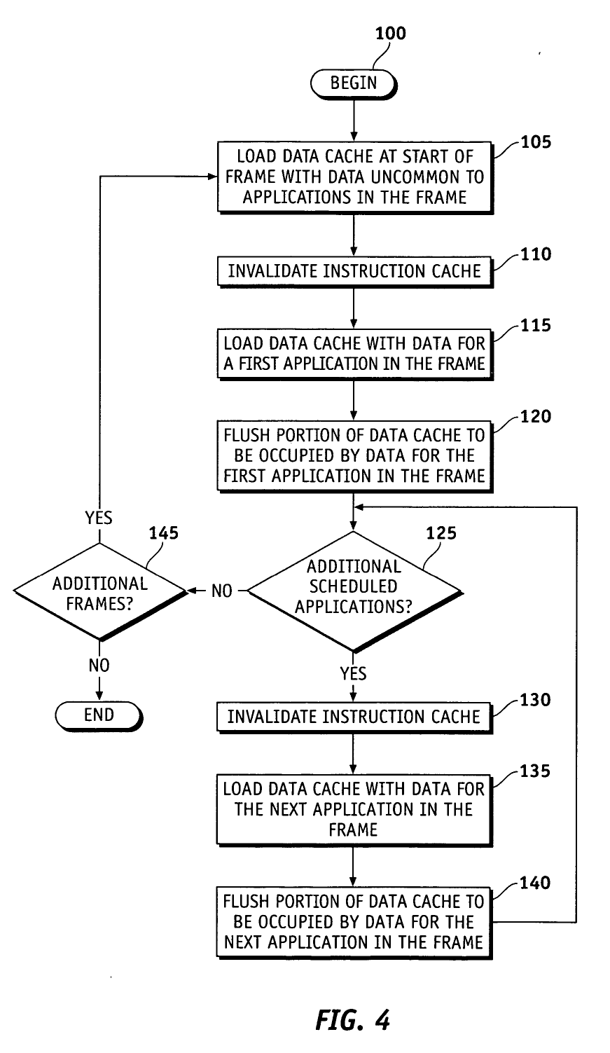

FIG. 4 is a flowchart of a method for partitioning a data cache in accordance with an exemplary embodiment. The method begins at 100. The CPU 12 shown in FIG. 1 loads the data cache at the start of a minor frame with data uncommon to the scheduled applications of the frame at step 105. The CPU 12 shown in FIG. 1 invalidates the instruction cache at step 110. A first application in the scheduled applications of the minor frame requests data cache, and the CPU 12 shown in FIG. 1 loads the data cache with data relevant to the first application in the frame at step 115. The CPU 12 shown in FIG. 1 flushes a portion of the data cache, to be occupied by data for the first application of the minor frame, to the main memory 18 shown in FIG. 1 at step 120. The CPU 12 shown in FIG. 1 then determines whether the minor frame has additional scheduled applications at step 125.

If the CPU 12 shown in FIG. 1 determines that an additional application is scheduled, the CPU 12 shown in FIG. 1 invalidates the instruction cache at step 130. The additional application or next application requests data cache, and the CPU 12 shown in FIG. 1 loads the data cache with data for the next application in the minor frame at step 135. The CPU 12 shown in FIG. 1 flushes a portion of the data cache, to be occupied by the data for the additional application in the minor frame, to the main memory 18 shown in FIG. 1 at step 140.

If the CPU 12 shown in FIG. 1 determines that an additional application is not scheduled, the CPU 12 shown in FIG. 1 determines whether additional frames are scheduled for processing at step 145. If the CPU 12 shown in FIG. 1 determines that an additional frame is scheduled for processing, the method returns to step 105 to load the data cache at the start of the additional frame with data uncommon to the applications in the such frame.

If the CPU 12 shown in FIG. 1 determines that no additional frames are scheduled for processing, the method ends. Although the method is described with regard to a computer system configured with an instruction cache and invalidating the instruction cache at steps 110 and 130, these invalidating steps 110, 130 are not critical to the performance of the invented method and are optionally included in the method. The cache frame based partitioning of the invented method may be configured to meet minimum execution times for applications in a variety of avionics systems.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A method for partitioning a data cache for a plurality of applications, the method comprising the steps of:
loading the data cache with a first data in a first frame, the first data uncommon to the plurality of applications, the first frame indicating a first sequence of the plurality of applications; and
loading the data cache with a second data within the first frame after said step of loading the data cache with the first data, the second data corresponding to a first application in the first sequence of the plurality of applications.

2. A method for partitioning a data cache according to claim 1 further comprising the step of:
invalidating an instruction cache prior to said step of loading the data cache with the second data.

3. A method for partitioning a data cache according to claim 1, wherein said step of loading the data cache with the second data comprises the step of:
flushing a portion of the data cache corresponding to a size of the second data.

4. A method for partitioning a data cache according to claim 1 further comprising the step of:
loading the data cache with a third data within the first frame and subsequent to said step of loading the data cache with the second data, the third data corresponding to a second application in the first sequence of the plurality of applications.

5. A method for partitioning a data cache according to claim 4, wherein said step of loading the data cache with the third data comprises the step of:
flushing a portion of the data cache corresponding to a size of the third data.

6. A method for partitioning a data cache according to claim 1 further comprising the step of:
loading the data cache with the first data in a second frame, the second frame indicating a second sequence of the plurality of applications.

7. A method for partitioning a data cache according to claim 6 further comprising the step of:
loading the data cache with a third data within the second frame and after said step of loading the data cache with the first data in the second frame, the third data corresponding to one application in the second sequence of the plurality of applications.

8. In a computer system having a data cache, an instruction cache, and a memory, the computer system operating a plurality of applications, a method for partitioning the data cache, the method comprising the steps of:
loading the data cache with a first data in a first frame, the first data unrelated to the plurality of applications, the first frame indicating a first scheduling sequence of the plurality of applications; and
loading the data cache with a second data after said step of loading the data cache with the first data, the second data corresponding to a first application in the first scheduling sequence of the plurality of applications.

9. A method for partitioning the data cache according to claim 8 further comprising the step of:
invalidating the instruction cache prior to said step of loading the data cache with the second data.

10. A method for partitioning the data cache according to claim 8, wherein said step of loading the data cache with the second data comprises the step of:
flushing a portion of the data cache to the memory, the portion of the data cache corresponding to a size of the second data.

11. A method for partitioning the data cache according to claim 8 further comprising the step of:
loading the data cache with a third data within the first frame and subsequent to said step of loading the data cache with the second data, the third data corresponding to a second application in the first scheduling sequence of the plurality of applications.

12. A method for partitioning the data cache according to claim 11, wherein said step of loading the data cache with the third data comprises the step of:
flushing a portion of the data cache to the memory, the portion of the data cache corresponding to a size of the third data.

13. A method for partitioning the data cache according to claim 8 further comprising the step of:
loading the data cache with the first data in a second frame, the second frame indicating a second scheduling sequence of the plurality of applications.

14. A method for partitioning the data cache according to claim 13 further comprising the step of:
loading the data cache with a third data within the second frame and after said step of loading the data cache with the first data in the second frame, the third data corresponding to one application in the second scheduling sequence of the plurality of applications.

15. A computer program product for causing an operating system to manage a data cache during operation of a plurality of processes, the program product comprising a computer usable medium having a computer readable program code embodied in the medium that when executed by a processor causes the operating system to:
load the data cache with a first data in a first frame, the first data uncommon to the plurality of processes, the first frame indicating a first sequence of the plurality of processes; and
load the data cache with a second data within the first frame and after loading the data cache with the first data, the second data corresponding to a first application in the first sequence of the plurality of processes.

16. A computer program product according to claim 15 further executable to cause the operating system to:
invalidate an instruction cache prior to loading the data cache with the second data.

17. A computer program product according to claim 15 further executable to cause the operating system to:
flush a portion of the data cache corresponding to a size of the second data.

18. A computer program product according to claim 15 further executable to cause the operating system to:
load the data cache with a third data within the first frame and subsequent to loading the data cache with the second data, the third data corresponding to a second process in the first sequence of the plurality of processes.

19. A computer program product according to claim 15 further executable to cause the operating system to:
load the data cache with the first data in a second frame, the second frame indicating a second sequence of the plurality of processes.

20. A computer program product according to claim 19 further executable to cause the operating system to:
load the data cache with a third data within the second frame and after loading the data cache with the first data in the second frame, the third data corresponding to one process in the second sequence of the plurality of processes.
